(19) United States
(12) Patent Application Publication
(10) Pub. No.: US 2005/0260549 A1
(43) Pub. Date: Nov. 24, 2005

(54) Method of analyzing question responses to select among defined possibilities and means of accomplishing same

(76) Inventors: Roslyn E. Feierstein, Ashland, KY (US); James M. Reneau, Russell, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/132,674

(22) Filed: May 19, 2005

Related U.S. Application Data
(60) Provisional application No. 60/572,330, filed on May 19, 2004.

(51) Int. Cl. G09B 19/00

(52) U.S. Cl. 434/236

(57) ABSTRACT

The disclosed invention is a computerized testing methodology which uses Yes/No answers to questions to make the most appropriate selection from a set of defined possibilities. With regard to a topic which is being analyzed, a set of possible outcomes is defined. A database of questions which bear upon these outcomes is developed and each outcome is ranked in relation to each question as to how much that question indicates that outcome. This is a serial ranking of 1 through the number of possible outcomes. Additional weight factors may be used along with these rankings. As questions are answered, these rankings and weights are used to calculate accumulating scores for the possible outcomes. A formula is provided to choose a balanced selection of questions initially and then shift to questions which focus on the indicated likely outcomes as the questioning progresses. Upon termination of the questioning process, the outcomes having the highest percent accumulated score to possible score are deemed indicated by the method. The process may be repeated to obtain a second most indicated outcome. Means of storing, using, and presenting the method are also disclosed.

### RELATED U.S. APPLICATION DATA

This application claims priority from U.S. Provisional application 60/572,330, filed on May 19, 2004. This application relates to a method of analyzing question responses to select among defined possibilities and means of accomplishing the same. The entire disclosure contained in U.S. provisional application 60/572,330, including the attachments thereto are incorporated herein by reference.

### FIELD OF THE INVENTION

This invention relates generally to a method for selecting the most appropriate outcome from a set of known, defined outcomes. More specifically, this invention is a method whereby Yes/No answers to a limited number of questions selected from a large database of empirically derived questions are used to screen the most appropriate choice or choices from a defined set of possible screening outcomes. The screening outcomes may be medical or mental health diagnoses, management decision options, resource allocations, etc. The database of questions is developed specific to the subject being analyzed.

### BACKGROUND OF THE INVENTION

There are many methods for evaluating a single characteristic or dimension of a subject. For example, many tests have been developed to examine behavior, intelligence, or problems within a company, factory, etc. This typically involves an evaluation with a specific objective and a single factor. The evaluation usually takes the form of a questionnaire with defined choices or options, and a computer may be used to evaluate, record, or monitor responses. Some computerized screening tools or tests utilize multiple categories but are time consuming and have not been created with the provider in mind. Rather the subject or object has been the focus, e.g., parent interviews, individual testing, worker productivity.

Typically, these scales, even if computerized, begin with questions being used in a process which is calibrated to that single scale or multiple categories. There are far fewer methods for simultaneously considering and evaluating more than one characteristic or dimension of a subject or objective, let alone, evaluating those several characteristics simultaneously in comparison with each other.

There are many fields in which such a multi-dimensional evaluation is done by a person of high skill and experience wherein it would be advantageous to replicate the same results with an automated evaluation system. This would speed up the evaluation process and allow a larger number of people to achieve a correct evaluation of a complex multi-dimensional subject. Computerized testing is accomplishing this in the field of mental health, e.g., psychiatry, psychology, etc. Longer multi-dimensional scales are shortened with similar validity, inter-rater reliability and general reliability. This suggests that computer science is on the cutting edge of revolutionizing the applications of diagnosis in this field. However, the present invention utilizes an original methodology that requires less time and has multiple applications in the field of psychological diagnosis alone, along with additional applications in non-clinical fields as well.

Among the many situations where this is so, is the field of mental health diagnosis, which is typically a time intensive diagnosis. A common situation is a primary care physician who sees patients for physical ailments and who may also need to understand a patient's mental status without having the extensive training required, or the ability to invest the needed time with the patient to reach that understanding. Indeed, with chronic situations, understanding a patient's mental status may be key to successful treatment of the physical ailments. Within a health care system, this situation is very important because it is one where an individual is most likely to interact with a professional. Unfortunately, as just noted, the time allocated for such interaction is often not sufficient for a complex diagnosis, and special training is needed. In addition to the time for initial evaluation, modern standards call for regular and frequent follow-up. Monitoring sessions every two weeks is a commonly suggested schedule.

### DESCRIPTION OF THE PRIOR ART

U.S. Pat. No. 4,996,642 by Hay is directed to providing accurate recommendations among a group of individuals for items such as movies and books and so on. The approach develops relationships among group members, making note of what books, movies, etc. that members liked previously, matching group members that have similar interests and establishing relationships between those people. Recommendations from people having similar interests will be weighted more strongly among members of the group making the recommendations. A member of the group may establish the criteria for what defines a good movie or other items being recommended. This is taken into consideration when developing the recommendations by other individuals. Past preferences within the group are used to establish similar preferences for future projection. This method is used within a single group and relationships must be developed within the group as well as applied within the group. It does not have the broader application from individual to individual taking a test or analyzing a situation.

U.S. Pat. No. 5,059,127 by Lewis et al. applies Item Response Theory and Bayesian decision theory to determine mastery and non-mastery of a topic. This method groups question items within a test into testlet pools. Items or questions are randomly selected from the pools. The responses to those items are used to guage the location of the individual on the scale in relation to the topic as far as being a master or non-master in the topic. Periodically, the test will examine the items and responses to determine if the test should be terminated or if further questions need to be asked. Once the test scores reveal that a decision has been reached, a test final result is delivered by the system. This is a method and system which focuses upon a single characteristic or feature, and an individual is evaluated on a scale against that, or about that particular feature or topic. The applicability of this patent is to a single topic, whereas, it is very desirable to be able to consider several different characteristics at the same time and evaluate them in relationship to each other.

U.S. Pat. No. 5,435,324 by Brill tracks a patient's psychological progress by digitally recording psychological test results over a period of time from initial testing through treatment. This invention utilizes a standard test derived from accepted clinical standards. The test results may be distilled to a single value for each time the test is administered over the tracking period. This single value is used to compare the state of the patient over the course of the tracking period. A predetermined benchmark can be used to introduce a time factor so that comparison to that benchmark would result in a time rate of change measurement of the patient's psychological condition over the tracking time period. While providing an ability to chart progress and time rate of change with digital assistance, this patent features traditional testing methods. In some cases, the test is administered on paper and adaptability is not a primary element of this approach.

Also pertinent to this field of art, is the Diagnostic Interview Schedule for Children (DISC) which was developed for the National Institutes of Mental Health. It ascertains diagnoses based on diagnostic criteria specified in the DSM, or Diagnostic and Statistical Manual of Mental Disorders, and is the property of Columbia University. The approach taken by the DISC is an extensive battery of questions, the answers to which are usually limited to “Yes” and “No”. A positive response to a question leads to a series of questions for further details relating to the diagnosis indicated by the initial question that elicited the positive response. This is essentially a decision tree approach. Once this tree has been pursued to its conclusion, a question for another new diagnosis is asked. If the answer is positive, then that tree is pursued to exhaustion. The analysis, then, is a highly structured series of decision trees administered in a rigidly set order. While a single module may be used to analyze a single specific diagnosis, an across the board diagnostic requires several modules of several questions each. A single module may take 20 minutes to administer with the across the board analysis requiring even more time, perhaps 120 minutes, so while the DISC is consistent with the diagnostic standard of the DSM, it requires a significant amount of time per diagnosis.

### SUMMARY OF THE INVENTION

In view of the prior art, it is a primary objective of the present invention to provide an improved method of using questions with binary answers to select the most appropriate items from a defined set of items.

It is an additional objective of the present invention to provide a means of implementing the method with a handheld digital device, personal computer, Internet system, or office network.

It is a further objective of the present invention to provide an analytical method which is easily applied to a wide range of decision making fields.

It is yet another objective of the present invention to provide a method which operates in a concise manner.

It is a still further objective of the present invention to apply the method to diagnose pain disorders.

It is still another objective of the present invention to apply the method to diagnose childhood mental disorders.

It is a yet still further objective of the present invention to provide a method which selects the top several most likely items.

It is a further objective of the present invention to provide a method consistent with the accepted standard in any given field, for example the DSM and ICD, or the Diagnostic Statistical Manual of Mental Disorders and the International Classification of Diseases, respectively, diagnostic manuals and current empirical research in the field of mental health.

The present invention comprises a methodology for using responses to questions that have two answer options to select the most appropriate outcomes from a defined set of known screening outcomes. For a particular subject of analysis, a set of “u” possible outcomes is defined. Along with this set of possible outcomes, a set of diagnostic questions is developed with the questions being relevant to the subject or objective being analyzed or assessed and bearing upon the “u” possible outcomes. A numerical value, or rank, is established between each question and each screening outcome. This numerical value, or rank, ranges from 0 to u−1 and a particular question has no duplicated rank values between it and the “u” possible screening outcomes, i.e. the “u” possible screening outcomes are ranked in order according to how strongly a positive answer to a particular question indicates the screening outcome.

In addition to the rank value, another value is associated between each question and each screening outcome. This value is an additional weighting factor. The weight value may be zero or non-zero with a non-zero value being used to indicate a particularly strong relationship between a positive answer to a question and a screening outcome. This weighting value may be non-zero and duplicated with respect to more than one screening outcome, indicating a subset of screening outcomes more strongly indicated by the particular question. The weighting and rank are known collectively as correlation factors.

To analyze a subject, questions are presented and answered with a binary, yes or no, and two sets of three running totals are kept with respect to each possible screening outcome. One set of running totals is dependent only on what questions are asked and is therefore a record of the maximum possible scores and the other set is dependent on how the questions are answered and is therefore a record of actual scores. The totals are used to direct the selection of successive questions as well as to score the results at the end of the analysis. Each set of totals includes a sum of the ranks for each screening outcome, a sum of the weighting value for each screening outcome, and a sum of points for each screening outcome, where the points are calculated by multiplying the weight plus one for a screening outcome times the rank for a screening outcome.

Initially, the values for the totals are set to zero. As a question is asked, its values for each screening outcome is added to the total for the possible scores. If a question is answered in the affirmative, then these values are added to the totals for the actual scores as well. If the answer is “no” then only those screening outcomes with non-zero weights will have their actual scores affected. For those screening outcomes with non-zero weights, which indicates particular relevance of a question with regard to those screening outcomes, the values associated with the question will be subtracted from the totals of the actual scores for those screening outcomes.

In this way, a record is kept for each screening outcome of the total of possible values and of the total of actual scores. When it is decided to terminate the analysis and evaluate the results, the total points scored by each screening outcome is divided by the respective total points possible to arrive at a percentage value of actual points to possible points for each possible screening outcome. Screening outcomes with the highest percentages are determined to be the indicated diagnosis, choice, or decision, depending on the specific application.

In the course of selecting the questions to be presented from the database, it is desirable to have a balanced group of questions asked initially while finishing with questions capable of focusing on the then most likely screening outcomes. This is done through the use of a selection process which utilizes the maximum possible point score for each of the possible screening outcomes and the total actual point score for each of the screening outcomes. This formula has a multiplier in it that is the dividend of an integer and the total number of possible screening outcomes. The integer is initially zero and is increased incrementally by one after each question asked. For each screening outcome, after each question asked, the product of the multiplier and the total points scored up to then is subtracted from the maximum possible points up to then for the screening outcome. The screening outcome having the lowest value produced by this formula is then the focus of the next question. That screening outcome is made the focus by selecting a previously unasked question which has the highest correlation with that screening outcome as indicated by the correlation factors. If there is more than one question with the same maximum correction factors, a pseudo-random number is used to select one of the highest correlated questions.

Early in the test, the multiplier will be a small fraction and reduce the effect of the actual total point scores upon the formula and leave the difference in the formula close to the possible point scores. Therefore, selecting the minimum result from the formula results in focusing upon a screening result which has had the lowest correlation factor to the questions asked so far. As the numerator in the multiplier is incremented, the products of the multiplier and the actual scores increase and the weight shifts to the actual scores. Then, selecting the minimum result from the formula results in asking a previously unasked question that focuses on the screening result having acquired the highest actual score to that point. An affirmative answer to this next question increases that total score, while a negative answer may reduce the score enough to produce a different screening outcome upon which to focus.

During the scoring of the test, in addition to the “Yes” and “No” options for answering a question, there is also a “Back” option which allows returning to any previous question and changing the response to that question and moving forward again. Any changed responses will change the total score values and therefore the questions asked when the test moves forward. Given the systematic nature of the question selection, different questions may be asked even when a question is responded to in the same way.

### BRIEF DESCRIPTION OF THE DRAWINGS

Additional utility and features of the invention will become more fully apparent to those skilled in the art by reference to the following drawings, which thoroughly illustrate the primary features of the present invention.

FIG. 1 shows the elements of the database of the present method.

FIG. 2 is a flow chart of the present method.

### DETAILED DESCRIPTION OF THE PREFERRED EMBODIMENT

The detailed description below is for a preferred embodiment in which the focus of analysis is pain disorders. The method could also be applied to the screening of childhood and adolescent mental health disorders. The number of screening outcomes, their designation, the questions referenced, etc. will reflect this particular embodiment where the screening outcomes are mental health diagnoses rather than business management choices or other analytical decisions. However, it is to be understood that the methodology may be applied to a variety of other fields and topics without departing from the spirit and scope of the invention. It should also be understood that the use of particular names for arrays, indexes, and formulas should not be regarded as narrowing the invention.

Similarly, when automated via software, the invention is not limited to storage on a particular type of medium. It may be stored on virtually any kind of computer memory. Such computer memory may include floppy disks, conventional hard disks, CD-ROM, Flash ROMS, non-volatile ROM, RAM, and CD-RW.

In understanding the invention in general and the embodiment in particular, care should be taken not to confuse an index and a number that might identify a particular program object and a value associated with that object. Hence, the method may analyze twelve different diagnoses which will be identified by the numerals one through twelve within an index, but each of these diagnoses will have a value zero through eleven associated between them and each question. The index numeral and value associated with a question should not be confused. Likewise, within the database of questions, a question will be identified by a numeral from one through “t”, a number equal to the total number of questions in the database. This identifying numeral should not be confused with the order in which the questions are asked, which is varied by the process steps. Also the method is not limited to analyzing among twelve different diagnoses but may analyze more or less than that number depending on the situation in which the method is developed and applied.

The core of the methodology is a three dimensional array or database which defines the correlations between the outcomes being screened and the questions used to screen for the outcomes. In the present embodiment, there are two correlation factors. One is a ranking from zero through u−1, where “u” is the number of possible screening outcomes, and each screening outcome has a unique ranking with respect to each question. Which is to say that each question has a correlation between it and each screening outcome that ranks the degree to which a positive answer to that question indicates a particular screening outcome. A value of u−1 for this rank is a high indication for that screening outcome, while a value of zero makes that particular screening outcome the least indicated by the question. These ranks are unique and not duplicated as between one question and all the screening outcomes.

The second correlation factor is a weighting factor used to indicate a subset of screening outcomes particularly strongly indicated by a positive answer to a question. In this embodiment, this weighting correlation factor is called a hallmark, which is consistent with the terminology of the field of mental health. Its value is an integer from 0 to h, where h in this embodiment is one. Although, in the current embodiment h is 1, a greater value than 1 could be used to create more subgroups within the set of possible choices. Also, in the current embodiment, the number of correlation factors is two, additional factors may be utilized and the total number of correlation factors may be represented by “v”. Also, while the weighting factor in this embodiment is 0 to h, the range may be shifted and appropriate adjustments made to apply the same basic methodology. Therefore, an index number associated with a screening outcome, along with an index number associated with a question, along with an index number associated with a correlation factor, will identify within the three dimensional array a particular value that defines the correlation between the question and the screening outcome.

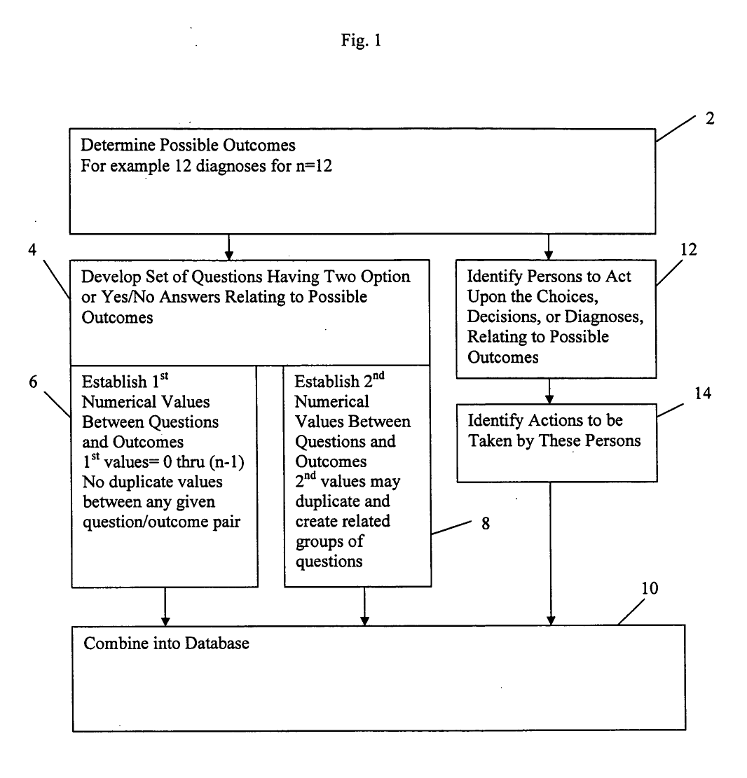

The flow chart of FIG. 1 illustrates the combination of the relationships between the choices and the questions into a database to achieve the analysis. Also shown in FIG. 1 is the association of persons capable of acting on the analysis provided by the method. Box 2 represents an initial survey of the subject area to determine the diagnoses, choices, or outcomes possible. Box 4 represents the development of questions which bear upon the subject area and which have two answer options, typically Yes and No. Boxes 6 and 8 represent the establishment of two sets of numerical values between the questions and the possible outcomes or choices. Again, these numerical values are indicative of how relevant a question is to a particular outcome. The relationships of the questions to the choices are combined into a database or array as shown by box 10.

In addition to analyzing a subject area or situation, the present invention may also assist in indicating the actions needed to be taken once the analysis method has been applied. Box 12 represent the designation of persons able to act upon the results of the analysis, while box 14 is indicative of the assignment of specific actions to those persons. This information is linked into the other information as shown by box 10, also.

In the present embodiment, the values representing the relationships between the questions and the choices, or outcomes, are used to compile scores for the diagnosis based upon the way the questions presented are answered. In addition to the array value for the correlation factors, point results are calculated using those array values. The point results are the product of the weight value plus one and the rank value.

Sets of arrays are used to keep running totals as the questions are answered. These running totals are kept in two two-dimensional arrays and two one-dimensional arrays. The two-dimensional arrays keep track of the correlation factors. One of these, the Possible Correlation Factor array, keeps sums of the correlation factors associated with all questions asked. When a question is asked, the values for its correlation factors are added to the respective values in this array, resulting in a Possible Correlation Factor Score. The other two-dimensional array, the Scored Correlation Factor array, accounts for the way the questions are answered and scored by adding the values for a question's correlation factors to the respective values in the array only when the question is answered in the affirmative. If a question is answered with a “No”, then those screening outcomes, or diagnoses, having a weight value greater than zero will have the values of their correlation factors subtracted from the respective values in the array. This results in a Net Correlation Factor Score.

The one dimensional arrays perform similar functions for the point scores. One of the one-dimensional arrays, the Possible Points for Screening Result array, keeps the totals of the point scores for each of the screening outcomes of all questions asked. This results in values of Possible Points Score. The other one-dimensional array, the Scored Points for Screening Result array, accounts for the way the questions are answered and scored by adding the values for a question's point scores to the respective values in the array only when the question is answered in the affirmative. If a question is answered with a “No”, then those screening outcomes, or diagnoses, having a weight value greater than zero will have their point score values subtracted from the respective values in the array. This results in a Net Point Score.

In addition to arrays that keep track of scores for screening outcomes, the present embodiment uses other arrays to keep track of the mechanics of the test. There is an array that tracks which questions are asked so that the question selection portion of the program does not repeat any question. A zero value associated with the index number for a question indicates that that question has not been asked. A one value indicates the question has been asked. Another array keeps a list of the index numbers of those questions which have been asked and the order in which they were asked. Likewise, an array keeps track of how the questions were answered. In an initial step of the program, these arrays are initiated to zero values throughout.

As to the particular screening outcomes and the substance of the questions, they are developed through research and knowledge of the subject area. In this particular area, there is ample empirical literature on pain disorders and childhood mental health disorders and indicating characteristics on which to base questions for diagnostic purposes. An accepted standard in this field is the Diagnostic and Statistical Manual of Mental Health Disorders, or DSM, published by the American Psychiatric Association. The DSM provides standard diagnoses and questions and is based upon published reviewed literature and research by over one thousand mental health professionals and members of several professional organizations in clinical settings and field trials. This embodiment is consistent with the DSM standard.

In this embodiment, one of the diagnoses included is a diagnosis of normal. Again, research, knowledge, and experience are used to rank which diagnoses are indicated by a positive answer to a particular question. In addition to the additive effect of the rank values, the weighting factor is used as a negative indicator for those screening outcomes having a weighting factor elevated above the others. When a question is answered in the negative, those screening outcomes which have weight factor values that indicate a strong correlation between the question and the screening outcome will have the product of the rank value and the weighting factor value subtracted from their actual score total.

The actual administration of the test for the preferred embodiment, which is for the diagnosis of childhood mental health disorders, is intended to be completed by the clinician interviewing the parent, or patient, or directly observing the individual being diagnosed. The clinician would interface with the software, entering the appropriate elicited or observed answer.

This interface, in the preferred embodiment, would be through a handheld device for clinical situations. However, for other embodiments other computer devices could be used, and the method could be applied to other analysis such as analyzing pain disorders.

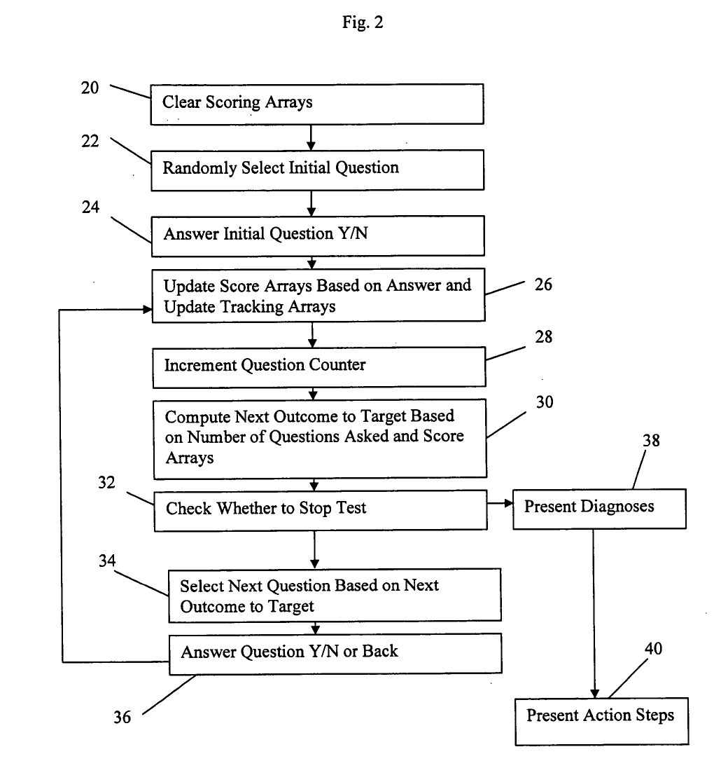

FIG. 2 illustrates the part of the method that uses the information in the database to analyze a particular situation in the subject area, in this case a patient being diagnosed for childhood mental disorders. With the start of a test, all arrays are initiated to zero, as indicated by box 20. The first question is randomly selected by the standard question process. The answer is entered by the clinician. FIG. 2 shows the ensuing process after an initial question is asked. The values, for that question, associated with the screening outcomes are added to the arrays for Possible Correlation Factors Score and Possible Points Score. This is shown at box 26. How the question is answered will determine how those same values will affect the scores in the Scored Points for Screening Result array and the Scored Correlation Factor array. If the answer is “Yes”, then the correlation factor values associated with each screening outcome along with the points calculated from those values are added to the respective values in the arrays. If the answer is “No”, then those screening outcomes having a weight value greater than zero have their correlation factors and points subtracted from the respective values in the arrays. Again, the weight is one of the two correlation factors, the other being the rank.

The question having been scored into the score arrays, other array values are adjusted to record the details of this iteration, also indicated at box 26. The question is marked as having been asked by changing from 0 to 1 the value associated with the question's index number in the appropriate array. Similarly, the order in which it was asked is recorded in association with the question's index number along with what the actual answer was.

Then, the initial step for selecting the next question is taken, including adding to the count of the number of questions that has been asked. This is represented at box 28. This procedure entails determining which screening outcome will be focused on by the next question. The Screening Result Leading Point Selection Formula is applied to the values in the Possible Points Score array and Scored Points for Screening Result array for each screening outcome. This formula takes the ratio of the current iteration to the total number of screening outcomes, multiplies it times the current value of the Scored Points for a screening outcome and subtracts this product from the current value of the Possible Points for a screening outcome. This is calculated for each screening outcome. The screening outcome having the lowest result from this formula will be selected as the focus of the next question, indicated at box 30. In the initial iteration, the ratio will be 0 and nothing will be subtracted from the Possible Points values. The counter for the numerator is incremented by one at this time.

Initially the low value of the ratio used in the formula will keep the weight of the Possible Point Scores in the formula greater than the weight placed on the values for the Scored Points for the screening outcomes. This means initially the test will ask a balanced set of questions by focusing on screening outcomes which have had the least opportunity to acquire points as evidenced by the Possible Point Score array. As questions are asked and the counter is incremented, the ratio will increase to larger fractions and then to a value of 1 and then to ratios greater than one.

To actually select the next question, the program searches the question database for the question having the largest point score in relation to the selected screening outcome, as shown by box 34. Also referenced, of course, is the array recording which questions have been asked. If more than one unasked question have the same largest point score for a selected screening outcome, a randomizing feature common to computers is used to randomly select among the tied questions.

This next question is presented and answered as shown at box 36. The responses may be “Yes”, “No”, or “Back”. Entering a “Yes” or “No” response moves the test forward as before. Selecting the “Back” response reverses the changes made as a result of the answer to the previous question, and re-presents the previous question for answer, or the test may be directed back to restart at any one of the previously asked questions, including the initial question. The changes undone by the “Back” response include entries in both the score arrays and the program tracking arrays. When the previous question is re-answered, the program moves forward again. If the answer has been changed, then obviously the scores will be changed and this changes what is the next presented question. Perhaps what is less obvious, is that even answering the question the same the second time, will not necessarily lead to the same question being asked as previously. If there was a tie in the question selection before, it is likely that the randomizing feature will choose a different question upon repeating the scoring and selection process. After the first question, the “Back” option will be available.

As the questions are asked and answered, scores totaled, tracking arrays updated, and the counter incremented, the focus of the selected questions will shift. As the counter increases, the ratio used in the formula increases, and the formula shifts the weight to screening outcomes that have actually accumulated higher scores. This shift means that screening outcomes with higher net scores in the Scored Points array will produce lower results from the formula. Again, the screening outcome with the lowest result from the formula is the focus of the next question.

Now, when the question database is searched for the unasked question having the highest point score associated with that screening outcome, it is searching for a question to validate the current indications of the scores in the arrays. A “Yes” response to this next question causes that question's values to be added to the scoring arrays and further confirms the current indications. A “No” answer will have some values associated with that question subtracted from values in the scoring arrays. It is the screening outcomes with weight values greater than zero which will have their scoring array values affected by a “No” answer. A “No” answer, therefore, readjusts the score for the previously most indicated screening outcome.

As each question is presented, the “Yes”, “No” and “Back” options are available each time. In this embodiment, the test is ended after twenty-five questions, a number determined by the standards of test construction. When the test is ended, the scores for the screening outcomes are evaluated by dividing each screening outcomes score in the Scored Points for Screening Result array by that same screening outcomes total in the Possible Points Score array. This produces a percentage of points actually scored of points possible to score for each screening outcome. The screening outcomes with the highest percentages are the most indicated diagnoses.

This particular embodiment has among its diagnoses a normal diagnosis. If normal, or within normal limits, signifying typical pediatric development is the most indicated screening outcome, it is presented as the test result. If “normal” is the second most indicated, that and the first most indicated result are presented. Otherwise the top two diagnoses having the highest percentage scores are presented as the results of the test.

In an alternative embodiment, the outcome having the highest percentage of points scored is selected as the first indicated outcome, and the test continues onward to select a second subset of questions to be answered. The starting point for this second set of questions is based on the scores of the outcomes up to that point. The answers to this second subset of questions are used to calculate a second set of scores for the possible outcomes and the highest percentage of this second set of scores is then used to select the second indicated diagnosis.

Once the test has made its evaluation, it is also capable of presenting courses of action based on current research and understanding in the field, including current prescription standards for diagnostic categories, treatment directives, and diagnostic category definitions. This embodiment presents different courses of action for the parties involved. A different set of guidelines are produced for the clinician, involved teachers and instructors, and parents. The varying guidelines encourage appropriate action by those interacting with the diagnosed individual. The presentation of diagnoses or decision is represented at box 38, while the presentation of actions to be taken is represented at box 40.

While the description of the preferred embodiment has relied upon specific names for arrays, and other objects within the program, it should be recognized that these may be varied without departing in any meaningful way from the spirit of the invention. Likewise, some variation in the order of operations, the questions used, or information presented by the program upon diagnosis would not be meaningful changes from the substance of the present invention. Terminology specific to other fields, such as hallmark is to the mental health field, may be used in embodiments applied to those other fields. Similarly, other fields may have more or fewer possible outcomes among which to choose. The present invention is adaptable to other fields of endeavor by determining the relevant possible outcomes, building a database of questions bearing upon the outcomes, and applying the methodology. The means of presentation may be a desktop computer, a network system including the Internet, or a handheld personal computing device. In the preferred embodiment, the test may be administered by a third party such as a clinician, teacher, practitioner, parent, or other user, or the test may even be self-administered by a patient. If the methodology is being applied in another field such as plant operations, potential users are employer, manager, operations manager, operator, etc. The possible fields of use for the methodology are many, and so types of possible users are nearly limitless.

1. A method of selecting the most appropriate choice or choices from a set of possible choices, comprising;
a) identifying the set of possible choices;
b) creating a set of questions pertaining to said possible choices, said questions having two answer options;
c) establishing a first numerical value associated with each question and choice pair;
d) establishing a second numerical value associated with each said question and choice pair;
e) determining the answers to a selected subset of said questions;
f) calculating scores for each of said possible choices based on the answers to said selected subset of said questions and said first numerical value associated with each said question and choice pair and said second numerical value associated with each said question and choice pair for the questions in said subset, and;
g) selecting the most appropriate choice or choices based on said scores.

2. The method of claim 1, wherein;
each said first numerical value is a unique integer and ranges from zero to the number of possible choices minus one.

3. The method of claim 1, wherein;
said set of possible choices has a number of subgroups and said second numerical value is equal to, or less than, said number.

4. The method of claim 1, wherein;
the questions in said subset of questions are selected sequentially by
a) randomly posing an initial question,
b) determining the answer to said initial question, and calculating said scores based upon said question and answer, and;
c) selecting the next question as a function of said scores derived from the previous question and successively re-calculating said scores which in turn are used to select each successive question and repeating this sequence through successive iterations until said iterations are stopped.

5. The method of claim 1, wherein said scores comprise;
two sets of three running totals with respect to each said possible choice, wherein;
a) a first set of three running totals comprises maximum scores, said maximum scores being
i) the sum of said first numerical values for the questions asked to that point;
ii) the sum of said second numerical values for the questions asked to that point, and;
iii) the sum of the product of said second numerical value plus one and said first numerical value for the questions asked to that point;
b) a second set of three running totals comprises actual scores, said actual scores being
i) the sum of said first numerical value for each said question answered in the affirmative minus said first numerical value for each said question answered in the negative if said question answered in the negative has a second numerical value associated with said choice that is non-zero;
ii) the sum of said second numerical value for each said question answered in the affirmative minus said second numerical value for each said question answered in the negative if said question answered in the negative has a second numerical value associated with said choice that is non-zero, and;
iii) the sum of the product of said second numerical value plus one and said first numerical value for each said question answered in the affirmative minus the product of said second numerical value plus one and said first numerical value for each said question answered in the negative if said question answered in the negative has a second numerical value that is non-zero.

6. The method of claim 4, wherein selecting said next question comprises;
a) calculating a multiplier by dividing the number of questions asked up to the current point by the number of possible choices;
b) for each possible choice, obtaining a difference by subtracting the product of said multiplier and said actual score derived from both said first numerical values and said second numerical values from the maximum score derived from both said first numerical values and said second numerical values;
c) determining a target possible choice by which possible choice obtains the lowest difference using its current maximum and actual scores, and;
d) selecting said next question, from among the questions that have not yet been asked, by choosing a question that has the highest first numerical value for said target possible choice.

7. The method of claim 6, wherein selecting said next question further comprises;
using a random operator to select said next question if more than one question have the same highest first numerical value.

8. The method of claim 4, further comprising;
the means to optionally return to any previous question, from said initial question forward, and means to change the answer to said previous question and continue forward with possibly new questions.

9. The method of claim 1, wherein;
said method is terminated after a predetermined number of questions has been asked.

10. The method of claim 9, wherein;
said predetermined number is determined through empirical study.

11. The method of claim 1, wherein;
said method is terminated when said score changes by less than a set percentage.

12. The method of claim 1, wherein;
said set of questions is developed from a recognized standard reference for the field associated with said choices.

13. The method of claim 12, wherein;
said field is pain disorders, said choices are diagnoses, and said reference is the DSM or ICD diagnostic manuals.

14. The method of claim 12, wherein;
said field is childhood mental disorders, said choices are diagnoses, and said reference is the DSM or ICD diagnostic manuals.

15. The method of claim 1, further comprising;
developing specific action steps to be taken with regard to each said choice by relevant persons and displaying or otherwise communicating said action steps.

16. The method of claim 5, wherein;
said most appropriate choice or choices, are selected by;
dividing each said choice's actual score derived from both said first numerical values and said second numerical values by its maximum score derived from both said first numerical values and said second numerical values, and;
selecting a first choice and a second choice based on the highest two percentages.

17. The method of claim 5, wherein;
said most appropriate choice or choices, are selected by;
dividing each said choice's actual score derived from both said first numerical values and said second numerical values by it's maximum score derived from both said first numerical values and said second numerical values, and;
selecting a first choice based on the highest percentage;
determining the answers to a second subset of questions;
calculating scores based on the answers to said second subset of questions;
dividing each said diagnosis's actual score derived from both said first numerical values and said second numerical values by its maximum score derived from both said first numerical values and said second numerical values, and;
selecting a second diagnosis based on the highest percentage of said scores calculated from determining the answers to said second subset of questions.

18. A method of diagnosing pain disorders, comprising;
a) identifying the set of possible diagnoses;
b) creating a set of questions pertaining to said possible diagnoses, said questions having two answer options;
c) establishing a first numerical value, named a rank, associated with each question and choice pair;
d) establishing a second numerical value, called a hallmark, associated with each said question and choice pair;
e) determining the answers to a selected subset of said questions;
f) calculating scores for each of said possible choices based on the answers to said selected subset of said questions and said rank associated with each said question and choice pair and said hallmark associated with each said question and choice pair for the questions in said subset, and;
g) selecting the most appropriate diagnosis or diagnoses based on said scores.

19. The method of claim 18, wherein;
each said rank is a unique integer and ranges from zero to the number of possible diagnoses minus one.

20. The method of claim 18, wherein;
each said hallmark has a value of zero or one.

21. The method of claim 18, wherein;
the questions in said subset of questions are selected sequentially by
a) randomly posing an initial question,
b) determining the answer to said initial question, and calculating said scores based upon said question and answer, and;
c) selecting the next question as a function of said scores derived from the previous question and successively re-calculating said scores which in turn are used to select each successive question and repeating this sequence through successive iterations until said iterations are stopped.

22. The method of claim 18, wherein said scores comprise;
two sets of three running totals with respect to each said possible choice, wherein;
a) a first set of three running totals comprises maximum scores, said maximum scores being
i) the sum of said rank values for the questions asked to that point;
ii) the sum of said hallmark values for the questions asked to that point, and;
iii) the sum of the product of said hallmark plus one and said rank for the questions asked to that point;
b) a second set of three running totals comprises actual scores, said actual scores being
i) the sum of said rank value for each said question answered in the affirmative minus said rank value for each said question answered in the negative if said question answered in the negative has a hallmark value associated with said choice that is non-zero;
ii) the sum of said hallmark value for each said question answered in the affirmative minus said hallmark value for each said question answered in the negative if said question answered in the negative has a hallmark value associated with said choice that is non-zero, and;
iii) the sum of the product of said hallmark value plus one and said rank for each said question answered in the affirmative minus the product of said hallmark value plus one and said rank value for each said question answered in the negative if said question answered in the negative has a hallmark value that is non-zero.

23. The method of claim 21, wherein selecting said next question comprises;
a) calculating a multiplier by dividing the number of questions asked up to the current point by the number of possible diagnoses;
b) for each possible diagnosis, obtaining a difference by subtracting the product of said multiplier and said actual score derived from both said rank values and said hallmark values from the maximum score derived from both said rank values and said hallmark values;
c) determining a target possible diagnosis by which possible diagnosis obtains the smallest said difference using its current maximum and actual scores, and;
d) selecting said next question, from among the questions that have not yet been asked, by choosing a question that has the highest rank value for said target possible diagnosis.

24. The method of claim 23, wherein selecting said next question further comprises;
using a random operator to select said next question, if more than one question have the same highest rank value.

25. The method of claim 21, further comprising;
the means to optionally return to any previous question, from said initial question forward, and means to change the answer to said previous question and continue forward with possibly new questions.

26. The method of claim 18, wherein;
said method is terminated after a predetermined number of questions has been asked.

27. The method of claim 26, wherein;
said predetermined number is determined through empirical study.

28. The method of claim 18, wherein;
said method is terminated when said score changes by less than a set percentage.

29. The method of claim 18, wherein;
said set of questions is developed from a recognized standard reference.

30. The method of claim 29, wherein;
said reference is the DSM or ICD diagnostic manuals.

31. The method of claim 18, further comprising;
developing specific action steps to be taken with regard to each said diagnosis by relevant persons and displaying, or otherwise communicating said action steps.

32. The method of claim 22, wherein;
said most appropriate diagnosis or diagnoses, are selected by;
dividing each said diagnosis's actual score derived from both said rank values and said hallmark values by its maximum score derived from both said rank values and said hallmark values, and;
selecting a first diagnosis and a second diagnosis based on the highest two percentages.

33. The method of claim 22, wherein;
said most appropriate diagnosis or diagnoses, are selected by;
dividing each said diagnosis's actual score derived from both said rank values and said hallmark values by it's maximum score derived from both said rank values and said hallmark values, and;
selecting a first diagnosis based on the highest percentage;
determining the answers to a second subset of questions;
calculating scores based on the answer to said second subset of questions;
dividing each said diagnosis's actual score derived from both said rank values and said hallmark values by it's maximum score derived from both said rank values and said hallmark values, and;
selecting a second diagnosis based on the highest percentage of said scores calculated from determining the answers to said second subset of questions.

34. A computer-readable medium having computer-executable instructions for performing a method comprising:
maintaining a database identifying the possible choices in an analytical situation and the numerical relationships between said possible choices and a large set of questions having two answer options;
selecting questions from said database;
using the answers to said questions to calculate scores for each said choices;
using said scores to select the correct choice in said analytical situation.

35. A computer-readable medium having stored thereon a data structure comprising:
a first field containing data representing possible choices in a situation requiring analysis;
a second field containing data representing questions of discernment with regards to said possible choices, said questions having two answer options;
a third field containing data representing a first numerical relationship between each said choice and each said question, and;
a fourth field containing data representing a second numerical relationship between each said choice and each said question.

36. The computer-readable medium having stored thereon the data structure of claim 26 further comprising;
a fifth field containing data representing the functions of persons capable of taking action with respect to said choices.

37. A system for selecting a subset of appropriate choices from among possible choices in a situation requiring analysis, said system comprising;
a storage device;
a processor programmed to:
maintain in the storage device a database identifying said choices, questions relating to said choices with said questions having two answer options, and two numerical value relationships between each said choice and each said question;
present a subset of questions from said database to users, and calculate scores for said choices based on answers provided by said users and said two numerical relationships between each said choice and each said answer, and;
present the most appropriate choices for said situation by evaluating said scores for said choices.
